(19) United States
(12) Patent Application Publication
(10) Pub. No.: US 2012/0287949 A1
(43) Pub. Date: Nov. 15, 2012

(54) POLARIZATION MULTIPLEXED SIGNALING USING TIME SHIFTING IN RETURN-TO-ZERO FORMAT

(75) Inventor: Stephen Michael Webb, Gravesend (GB)

(73) Assignee: XTERA COMMUNICATIONS, INC., Allen, TX (US)

(21) Appl. No.: 13/468,336

(22) Filed: May 10, 2012

Related U.S. Application Data
(60) Provisional application No. 61/486,148, filed on May 13, 2011.

(51) Int. Cl. H04J 14/06; H04J 14/00

(52) U.S. Cl. 370/536; 398/65

(57) ABSTRACT

Polarization multiplexing by encoding data using a return-to-zero format, and by interleaving the constituent orthogonal polarization components such that the data-carrying portion of the bit window from one orthogonal polarization component occupies the zero portion of the bit window for the other orthogonal polarization component.

### CROSS-REFERENCE TO RELATED APPLICATIONS

This application claims the benefit under 35 U.S.C. 119(e) of U.S. Provisional Application No. 61/486,148 filed May 13, 2011, which provisional patent application is hereby incorporated by reference in its entirety.

### BACKGROUND

Fiber-optic communication networks serve a key demand of the information age by providing high-speed data between network nodes. Fiber-optic communication networks include an aggregation of interconnected fiber-optic links. Simply stated, a fiber-optic link involves an optical signal source that emits information in the form of light into an optical fiber. Due to principles of internal reflection, the optical signal propagates through the optical fiber until it is eventually received into an optical signal receiver. If the fiber-optic link is bi-directional, information may be optically communicated in reverse typically using a separate optical fiber.

Fiber-optic links are used in a wide variety of applications, each requiring different lengths of fiber-optic links. For instance, relatively short fiber-optic links may be used to communicate information between a computer and its proximate peripherals, or between a local video source (such as a DVD or DVR) and a television. On the opposite extreme, however, fiber-optic links may extend hundreds or even thousands of kilometers when the information is to be communicated between two network nodes.

Long-haul and ultra-long-haul optics refers to the transmission of light signals over long fiber-optic links on the order of hundreds or thousands of kilometers. Typically, long-haul optics involves the transmission of optical signals on separate channels over a single optical fiber, each channel corresponding to a distinct wavelength of light using principles of Wavelength Division Multiplexing (WDM) or Dense WDM (DWDM).

Transmission of optical signals over such long distances using WDM or DWDM presents enormous technical challenges, especially at high bit rates in the gigabits per second per channel range. Significant time and resources may be required for any improvement in the art of high speed long-haul and ultra-long-haul optical communication. Each improvement can represent a significant advance since such improvements often lead to the more widespread availability of communications throughout the globe. Thus, such advances may potentially accelerate humankind's ability to collaborate, learn, do business, and the like, with geographical location becoming less and less relevant.

Optical communication systems may communicate optical signals using polarization multiplexing. In polarization multiplexing, a signal is polarized and split into orthogonal signal components. Each signal component is encoded with data according to a modulation format, for example, phase-shift keying (PSK) modulation. The signal components are then combined for transmission. A receiver splits the signal into two orthogonal signal components. Each signal component is then demodulated to retrieve the transmitted data. Among its other advantages, polarization multiplexing may double the transmission capacity of a channel.

Polarization multiplexing, however, may experience difficulties. As an example, the state of polarization (SOP) of the signal may change during transmission from the transmitter to the receiver. Accordingly, the receiver may need to compensate for this change. Compensating for the change, however, may be difficult in certain situations.

### BRIEF SUMMARY

At least one embodiment described herein relates to the performance of polarization multiplexing by encoding data using a return-to-zero format, and by interleaving the constituent orthogonal polarization components such that the data-carrying portion of the bit window from one orthogonal polarization component occupies the zero portion of the bit window for the other orthogonal polarization component. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates one embodiment of an optical transmission system for communicating a signal using polarization multiplexing;

FIG. 2 is a block diagram of one example of a polarization multiplexing and transmitting apparatus that may be employed by the transmitter shown in FIG. 1;

FIG. 3 shows one example of an optical receiver arrangement that may be employed in receiver of FIG. 1;

FIG. 4 shows the optical receiver arrangement depicted in FIG. 3 for a partially misaligned polarization state between the received polarization multiplexed optical signal and polarization beam splitter; and

FIG. 5 shows the optical receiver arrangement depicted in FIG. 3 for a fully misaligned polarization state between the received polarization multiplexed optical signal and polarization beam splitter.

### DETAILED DESCRIPTION

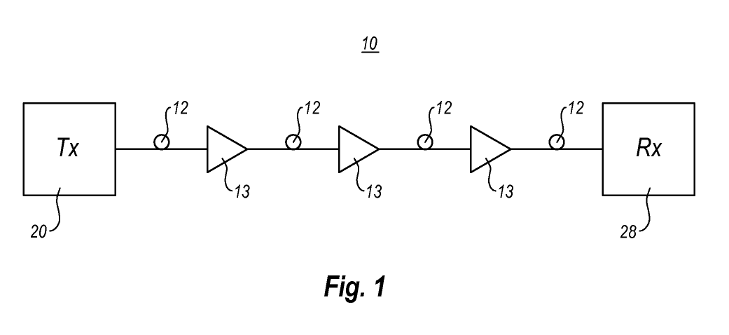

FIG. 1 illustrates one example of an optical transmission system 10 for communicating a signal using polarization multiplexing. According to one embodiment, system 10 communicates optical signals having, for instance, a frequency of approximately 1550 nanometers, and a data rate of, for example, 10, 20, 40, or over 40 gigabits per second. A signal may communicate any suitable information such as voice, data, audio, video, multimedia, other information, or any combination of the preceding. In this particular example the transmission system 10 is illustrated as a long-haul optical transmission system such as an undersea optical communication system. However, the method and techniques described herein are more broadly applicable to all types of optical communication systems, including long-haul, short-haul and metro network based systems.

According to the illustrated example, system 10 includes a transmitter 20, optical fiber spans 12, optical amplifiers 13 and receiver 28. Transmitter 20 is operable to communicate optical signals to the receiver 28. Transmitter 20 and receiver 28 may communicate according to one or more modulation formats. A modulation format refers to a technique for modulating a signal in a particular manner to encode data into the signal. One example of a suitable modulation format includes a class of formats referred to as Return-To-Zero (RZ) modulation. One example of an RZ modulation format that may be employed is RZ phase-shift keying (PSK) modulation, and, more particularly, RZ differential PSK (RZ-DPSK) modulation. In DPSK modulation, data is encoded as phase shifts between successive bits. According to n-phase-shift keying (n-PSK) modulation, n different phase shifts may be used to encode p bits per symbol, where n=2^{p}. For example, differential binary PSK (DBPSK) uses two phase shifts to encode one bit per symbol, and differential quadrature PSK (DQPSK) uses four phase shifts to encode two bits per symbol. Of course, a wide variety of other modulation formats may be employed as well.

The optical data signals produced in any of the aforementioned formats are transmitted across the optical transmission system shown in FIG. 1, repeatedly being attenuated and amplified, as well as possibly dispersion managed, before reaching the optical receiver 28.

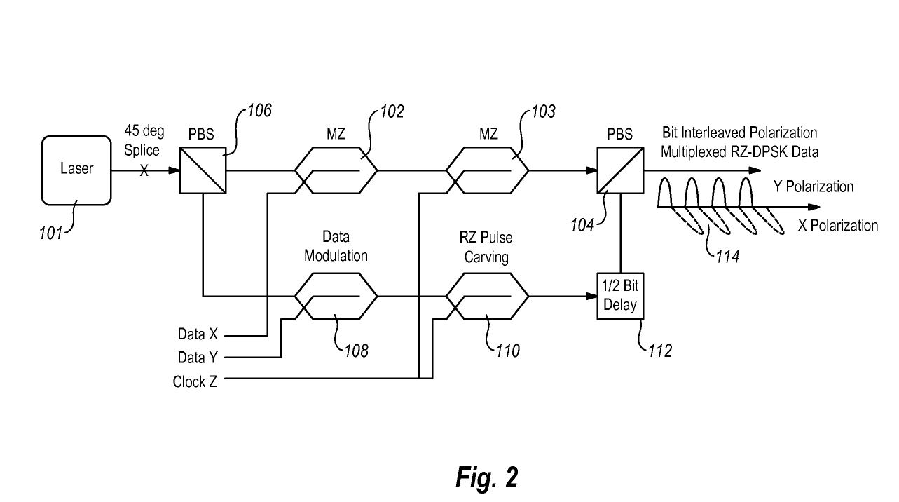

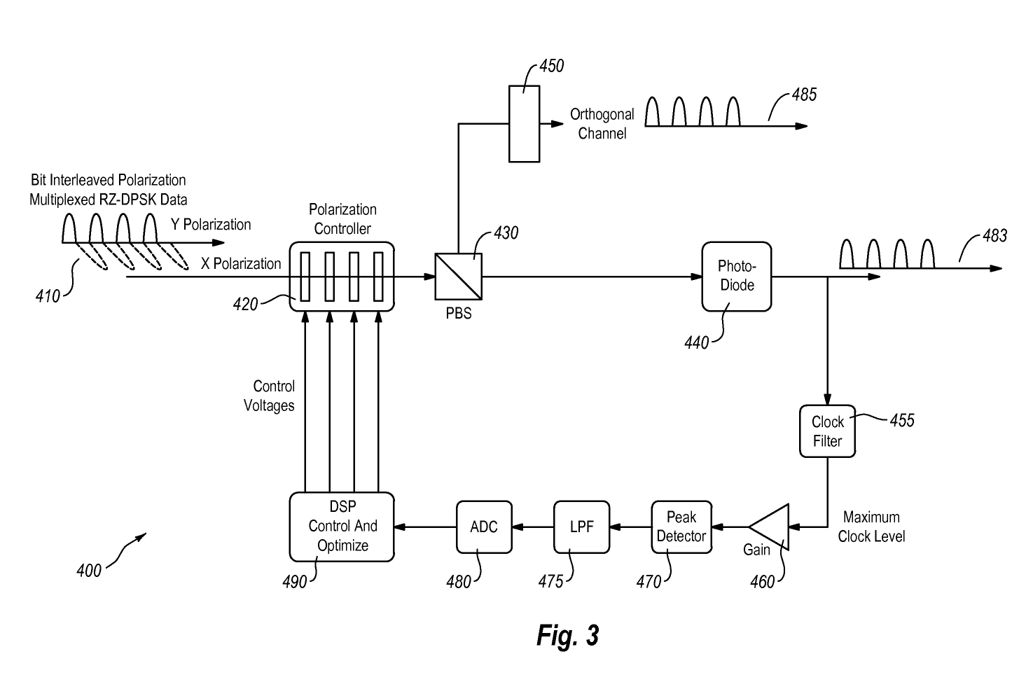

According to one embodiment, transmitter 20 modulates a signal using polarization multiplexing to encode data in a signal. Receiver 28 demodulates the signal using polarization demultiplexing to decode the data encoded in the signal. Transmitter 20 and receiver 28 may perform modulation and demodulation as described with reference to FIGS. 2 and 3, respectively.

FIG. 2 is a block diagram of one example of a polarization multiplexing and transmitting apparatus that may be employed by the transmitter 20 shown in FIG. 1. The polarization multiplexing and transmitting apparatus generates polarization multiplexed light by multiplexing respective modulated signal components having varying intensities and orthogonal polarization directions. As shown in FIG. 2, the polarization multiplexing and transmitting apparatus 100 includes a light source 101, polarization beam splitter (PBS) 106, optical data modulators 102 and 108, pulse carving modulators 103 and 110, PBS 104 and delay line 112.

The light source 101 generates and outputs a pulsed or continuous wave optical beam, which is split by PBS 106 into two orthogonal beams with equal powers. In this example the beam that is output from the light source 101 is a continuous wave optical beam. The light source 101 may be, for example, a laser or an LED. One of the orthogonal beams is directed to a first optical data modulator 102, which modulates data in one of many possible formats such as return-to-zero on-off keying (RZ-OOK) or RZ-differential phase shift keying (RZ-DPSK) onto the orthogonal beam based on a first data signal X, thereby producing an optical data signal that is directed to the first pulse carving modulator 103. The first optical data modulator 102 may be, for example, a Mach Zehnder intensity modulator. The first pulse carving modulator 103 is a return-to-zero (RZ) pulse carver that carves RZ pulses out of the optical data signal based on a clock signal Z. The first pulse carving modulator 103 may be, for example, a dual-drive Mach-Zehnder modulator using sinusoidal drive signals at either the data rate or at half the data rate. The resulting RZ-DPSK optical signal is directed to PBS 104.

The second orthogonal beam produced by the PBS 106 is modulated in a similar fashion by second data modulator 108 (based on a data signal Y) and second RZ pulse carving modulator 110. A delay line 112 adds a relative delay of ½ bit so that the RZ-DPSK optical signal streams produced at the output of delay line 112 can be interleaved or multiplexed in time by PBS 104 to produce a polarization multiplexed RZ-DPSK or RZ-OOK signal at its output. Of course, delay by (N+½) bit delay (where N is a whole number), will accomplish the same interleaving effect, such that the data-carrying portion of the bit window from one orthogonal polarization component occupies the zero portion of the bit window for the other orthogonal polarization component. The resulting polarization multiplexed output signal 114 has an amplitude modulation at twice the clock frequency. Since the two orthogonal polarization components of the signal have little or no overlap with one another, the peak power of the polarization multiplexed signal is reduced, thereby reducing non-linear impairments that may arise at higher optical power levels.

FIG. 3 shows one example of an optical receiver arrangement 400 that may be employed in receiver 28 of FIG. 1. Receiver arrangement 400 may include one or more suitable components operable to demodulate a signal 410 using polarization demultiplexing. According to the illustrated embodiment, receiver 400 includes a polarization controller 420, a PBS 430, photodetectors 440 and 450 and a polarization feedback mechanism, which in the illustrated embodiment includes clock filter 455, amplifier 460, peak detector 470, low pass filter 475, ADC 480 and control circuit 490.

The polarization controller 420 is configured to compensate for polarization fluctuations to provide a stable state of polarization (SOP). In particular, polarization controller 420 realigns the polarization state of the two orthogonally polarized incoming signals from transmitter 20 with the axes of a polarization beam splitter (PBS) 430 so as to avoid crosstalk between signals. Polarization controller 420 may have any suitable setting to align the polarization of the output orthogonally polarized signals to the input of the PBS 430. For example, polarization controller 420 may be set to approximately 45 degrees. Polarization controller 420 receives instructions from the polarization feedback mechanism, as described in more detail below.

The polarization controller 420 may employ any suitable technology and may be, for example, a lithium niobate based controller, an opto-ceramic based controller or a fiber squeezer based controller. In some implementations the polarization controller is endless, which means it can transform polarization states which are varying without the need to reset the polarization controller or its control voltages. Typically, the polarization controller should at least be able to be reset without disrupting the optical signal in order to provide an interruption-free signal output.

In many technologies the basic building block of the polarization controller 420 is an optical waveplate. The waveplate separates the incoming optical signal into two orthogonal polarizations and imposes a relative optical phase shift. For example, a λ/2 waveplate oriented at X degrees to the incoming linear polarization rotates it by 2X degrees., e.g., a 45 degree oriented λ/2 plate rotates the signal by 90 degrees. In another example, a λ/4 waveplate at 45 degrees transforms a linear polarization to a circular polarization. The polarization controller 420 is generally implemented as a collection of cascaded waveplates which are controlled by an external parameter, such as feedback from a control circuit 490. Each waveplate in the polarization controller 420 can have two control parameters, i.e. its axis of orientation and its relative phase delay order. Some polarization control methods control both parameters and some only one, with corresponding trade-offs.

While the present invention contemplates any polarization control method, in some implementations the polarization controller 420 employs a four waveplate configuration to allow endless control without steps or controller wind-up. Normally, three waveplates are needed to provide arbitrary control. However, at some point one or more of the plates will require unwinding if it reaches some end-stop. By adding a fourth waveplate to the configuration, control can be maintained during the unwind procedure.

A control circuit 490 such as a DSP, for example, generates a control signal that directly drives the waveplate voltages in the correct and optimal directions to compensate for changes in the polarization of the incoming polarization multiplexed signal 410. The control circuit 490 receives feedback from the feedback mechanism discussed below.

Returning to FIG. 3, polarization beam splitter (PBS) 430 splits the signal to yield orthogonal signal components, where each signal component is to be transformed into an electrical signal by photodetectors 440 and 450, respectively. The signal may be split in any suitable manner. According to one embodiment, the signal is split into orthogonal signal components 483 and 485 such that one signal component is aligned at or near 100% transmission along Eₓ and the other at or near 100% transmission along E_{y}.

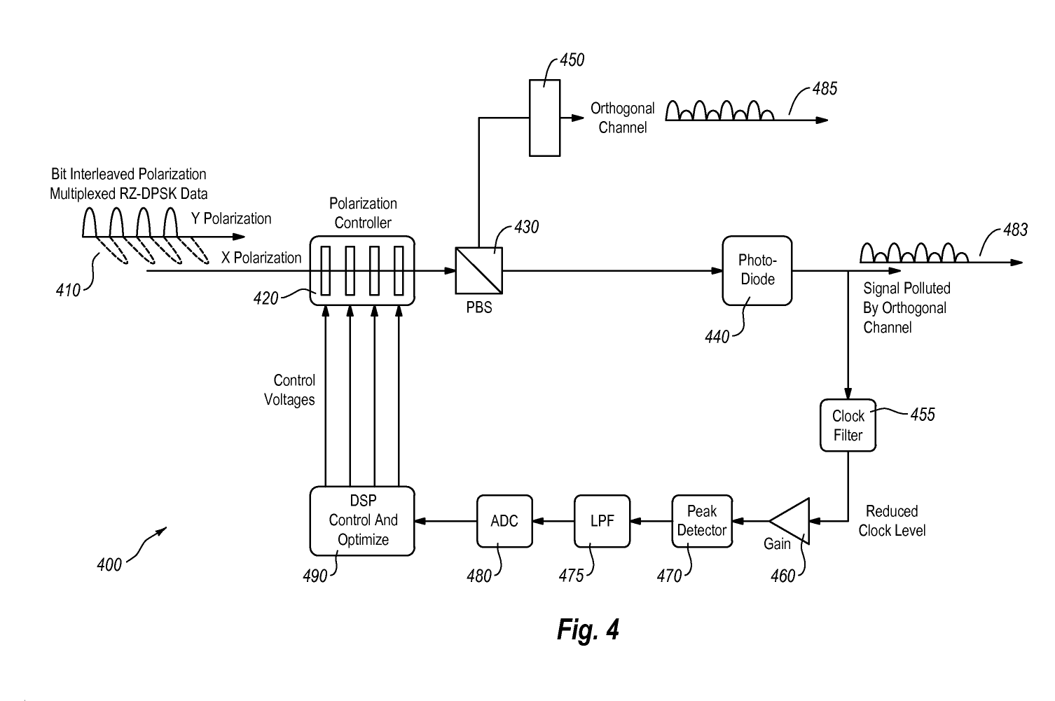

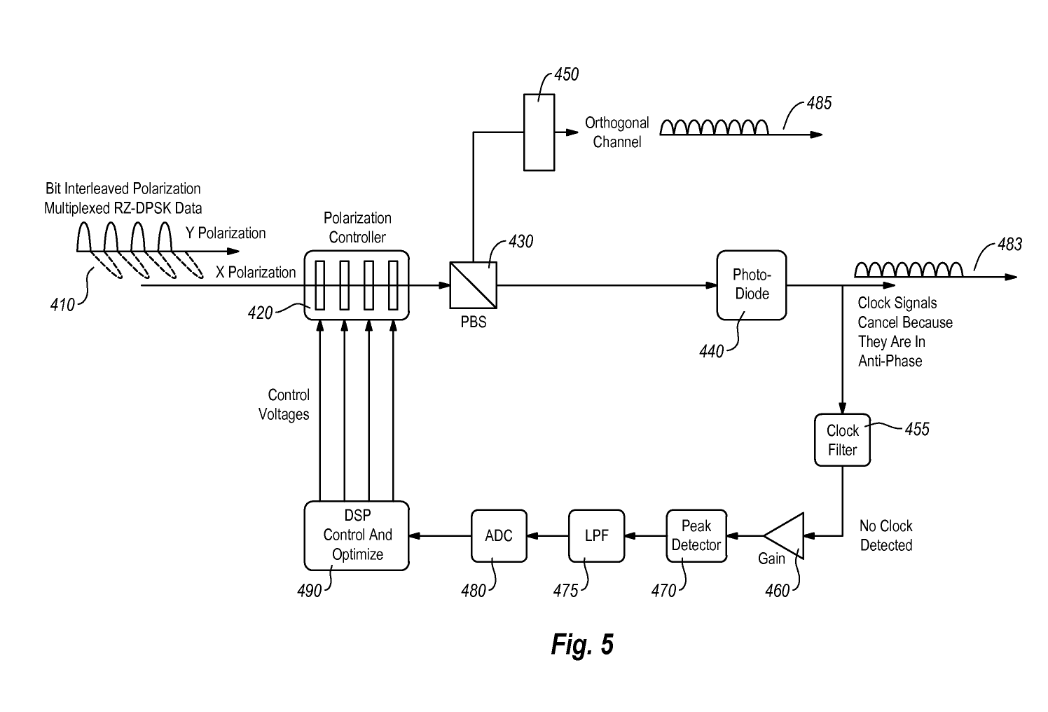

As previously mentioned, when the polarization controller 420 has been properly adjusted the polarization states of the polarization multiplexed signal 410 are aligned with the axes of PBS 430 and the cross-talk between the demultiplexed signal components 483 and 485 is minimized. As a result, the amplitude of the clock signal in the demultiplexed signal components 483 and 485 is maximized. On the other hand, if the polarization controller 420 incorrectly adjusts the polarization states, the demultiplexed signal components 483 and 485 will be partially corrupted with one another. In this case the amplitude of the clock signal in each of the demultiplexed signals 483 and 485 will be reduced. This situation is shown in FIG. 4, which shows the same receiver arrangement 400 depicted in FIG. 3 but with a misalignment between the polarization states of the polarization multiplexed signal 410 and the axes of the PBS 430. In this example the demultiplexed signal components exhibit some crosstalk from one another, thereby reducing the amplitude of the primary component. In FIG. 5, which also shows receiver arrangement 400, the misalignment between the polarization states of the polarization multiplexed signal 410 and the axes of the PBS 430 is further corrupted so that the amplitude of the two orthogonal components 485 and 483 respectively provided at the output of each photodetector 440 and 450 are equal to one another. Thus, in FIG. 5, cross-talk between the components 485 and 483 is at a maximum.

The above analysis shows that when the polarization states of the polarization multiplexed signal 410 and the axes of PBS 430 are properly aligned the amplitude of the clock signal is maximized. Thus, a feedback mechanism may be provided by tracking the clock signal in one or both of the demultiplexed signal components 483 and 485 and adjusting the polarization controller 420 so that the clock signal is maximized. The receiver arrangement 400 depicted in FIGS. 3-5 shows one implementation of a feedback mechanism that operates in this manner.

As shown, the feedback mechanism includes a clock filter 455 that is tuned to the clock signal and which receives a portion of the demultiplexed signal component 483 appearing at the output of the photodiode 440. For instance, if the bit rate of the demultiplexed component 483 is 20 GHz, the clock filter might be a narrow pass filter that allows the frequencies at 20 GHz to pass, while filtering out other frequencies. As an example, the clock filter 455 might have a bandwidth of 2 GHz.

The filtered clock signal is then amplified by an electrical gain element 460. While the clock filter 455 and the gain element 460 are illustrated as separate components, they might also be a single component such as, for example, a narrow band amplifier suitably configured to pass the frequency of the bit rate of the demultiplexed signal component 483.

The resulting signal may then be directed to a peak detector 470, which may be a diode with a high frequency response, to thereby substantially rectify the signal. The rectified signal is then pass through a low pass filter 475 which averages the rectified signal to produce a DC signal that detects the peak of the signal 483. The higher the peak, the more in-tune is the polarization controller. In one embodiment, the low pass filter 475 is an RC circuit that has a cut-off frequency at about 1 Megahertz, whereas the polarization controller 420 operates at about 100 Kilohertz.

The resulting peak signal is then provided to an analog/digital converter 480, which produces a digital signal representative of the strength or amplitude of the clock signal. The control circuit 490 receives this digital signal and, in response, adjusts the polarization controller 420 so that the received digital signal is maximized. In this way alignment between the polarization states of the polarization multiplexed signal 410 and the axes of PBS 430 can be maintained.

As an alternative example, the clock filter 455 may be tuned to twice clock frequency. For instance, if the clock frequency of the demultiplexed signal component were 20 GHz, the clock filter 455 might be configured to pass 40 GHz. Referring to FIG. 5, when the polarization controller is completely misaligned, the result is the demultiplexed signal component 483 carries a signal with a strong 40 GHz component. In this case, that peak would be detected and converted into digital form using components 460, 470, 475 and 480. In this case, the purpose of the control circuit 490 would be to minimize the received digital signal to thereby correct misalignment and cross-talk between the orthogonal signal components.

The functionality performed by the control circuit 490 which is necessary to generate the control signal may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

The embodiment of FIGS. 3 through 5 illustrated a receiver in which the feedback mechanism is primarily implemented in analog (except for the control circuit 490). However, the receiver may also be configured to perform polarization demultiplexing, in which case the clock filter 455, gain element 460, peak detector 470, and low pass filter 475 may be implemented digitally.

Accordingly, the principles described herein permit for a framework based mechanism for formulating claims in a desired format. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An optical transmitter comprising:
a light source that generates and outputs a pulsed or continuous wave optical beam;
a polarization beam splitter that splits the optical beam into first and second orthogonal polarization components;
a first optical data modulator that receives the first orthogonal polarization component and modulates data onto the first orthogonal polarization component using a return-to-zero format;
a second optical data modulator that receives the second orthogonal polarization component and modulates data onto the second orthogonal polarization component using a return-to-zero format;
a delay component that delays the modulated second orthogonal polarization component; and
an optical multiplexer that combines the modulated first orthogonal polarization component and the delayed and modulated second orthogonal polarization component, wherein the delay introduced by the delay component is sufficient that the orthogonal polarization components are interleaved when combined by the optical multiplexer.

2. The optical transmitter in accordance with claim 1, wherein the return-to-zero format of the first orthogonal polarization component, and the return-to-zero format of the second orthogonal polarization component is the same return-to-zero format.

3. The optical transmitter in accordance with claim 1, wherein the return-to-zero format of the first orthogonal polarization component is return-to-zero on-off keying (RZ-OOK).

4. The optical transmitter in accordance with claim 1, wherein the return-to-zero format of the first orthogonal polarization component is return-to-zero differential phase shift keying (RZ-DPSK).

5. The optical transmitter in accordance with claim 1, wherein the delay component introduces a one-half bit of delay.

6. The optical transmitter in accordance with claim 1, wherein the delay component introduces an N+½ bit relative delay, where N is a whole number.

7. An optical receiver, comprising:
a polarization controller that adjusts a polarization state of an externally received polarization multiplexed optical signal based on receipt of a control signal, said polarization multiplexed optical signal having a clock signal modulated thereon;
a polarization splitter that splits the polarization multiplexed optical signal received from the polarization controller into first and second orthogonal polarization components;
a first optical detector for converting the first orthogonal polarization components into a first electrical signal;
a second optical detector for converting the second orthogonal polarization component into a second electrical signal; and
a feedback circuit for generating the control signal based on a characteristic of the clock signal extracted from the first or second electrical signals.

8. The optical receiver in accordance with claim 7, wherein the control signal causes the polarization controller to adjust the polarization state of the externally received polarization multiplexed optical signal so that an amplitude of the clock signal is maximized.

9. The optical receiver in accordance with claim 7, wherein the feedback circuit includes a filter tuned to a frequency of the clock signal and coupled to an output of the first optical detector.

10. The optical receiver in accordance with claim 9, wherein the feedback circuit further includes:
a peak detector arrangement for receiving the clock signal from the filter and generating an output signal representative of the clock signal amplitude; and
a control circuit for generating the control signal in response to receipt of the output signal from the peak detector arrangement.

11. The optical receiver in accordance with claim 7, wherein the polarization multiplexed optical signal is an optical signal modulated in accordance with an RZ format having RZ pulses based on the clock signal.

12. The optical receiver in accordance with claim 11, wherein the optical signals is an RZ-DPSK signal.

13. The optical receiver in accordance with claim 7, wherein the feedback circuit is configured to generate the control signal based on a characteristic of the clock signal that causes a reduction in cross-talk between the first and second orthogonal polarization components.

14. The optical receiver in accordance with claim 7, wherein the control signal causes the polarization controller to adjust the polarization state of the externally received polarization multiplexed optical signal so that an amplitude of the clock signal is minimized.

15. A method for demultiplexing an optical signal, comprising:
receiving a polarization multiplexed optical signal having a clock signal modulated thereon;
splitting the polarization multiplexed optical signal received from the polarization controller into first and second orthogonal polarization components; and
adjusting a polarization state of the polarization multiplexed optical signal based on a characteristic of the clock signal derived from at least one of the first or second orthogonal polarization components.

16. The method in accordance with claim 15, further comprising adjusting the polarization state of the polarization multiplexed optical signal to align the polarization state of the polarization multiplexed optical signal with a polarization axis of a polarization splitter used to split the polarization multiplexed optical signal into the first and second orthogonal polarization components.

17. The method in accordance with claim 15 wherein the characteristic of the clocks signal is its amplitude.

18. The method in accordance with claim 17, further comprising adjusting the polarization state of the polarization multiplexed optical signal to maximize the amplitude of the clock signal.

19. The method in accordance with claim 17, further comprising adjusting the polarization state of the polarization multiplexed optical signal to minimize the amplitude of the clock signal.

20. The method in accordance with claim 19, wherein the clock signal is twice the bit rate of each of the first and second orthogonal polarization components.
